(19) United States
(12) Patent Application Publication
(10) Pub. No.: US 2009/0019286 A1
(43) Pub. Date: Jan. 15, 2009

(54) Watermark Detection

(75) Inventor: David K. Roberts, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,818

(22) PCT Filed: Feb. 8, 2005
(86) PCT No.: PCT/IB05/50493

§ 371 Date: Aug. 9, 2006

(30) Foreign Application Priority Data
Feb. 14, 2004 (GB) 0403327.0

(51) Int. Cl. H04L 9/00

(52) U.S. Cl. 713/176

(57) ABSTRACT

A detector (100) detects the presence of a watermark in an information signal. The information signal is correlated with an expected watermark (Wi) for each of a plurality of relative positions of the information signal with respect to the watermark to derive a set of correlation results (64). Part of the correlation results (64) are cross-correlated (82) with information (81) about an expected shape of a correlation peak in the results. This can improve the sensitivity of the detector (100). The cross-correlation result (84) is compared with a threshold at peak detection unit (85). The threshold used in this comparison (85) is set in an adaptive manner according to the expected shape. The information (81) about an expected shape of the correlation peak can be based on knowledge of processing operations that the information signal has undergone or expected to have undergone or from the shape of previous correlation results.

This invention relates to detecting a watermark in an information signal.

Watermarking is a technique in which a label of some kind is added to an information signal. The information signal to which the watermark is added can represent a data file, a still image, video, audio or any other kind of media content. The label is embedded in the information signal before the information signal is distributed. The label is usually added in a manner which is imperceptible under normal conditions, in order that it does not degrade the information signal, e.g. a watermark added to an audio file should not be audible under normal listening conditions. However, the watermark should be robust enough to remain detectable even after the information signal has undergone the normal processes during transmission, such as coding or compression, modulation and so on.

Many watermarking schemes employ correlation as a detection technique, with a signal under test being correlated with a signal containing a known watermark. In these systems, the presence of a watermark is indicated by one or more peaks in the correlation results. The paper “A Video Watermarking System for Broadcast Monitoring”, Ton Kalker et al., Proceedings of the SPIE, Bellingham, Va. vol. 3657, 25 Jan. 1999, p. 103-112, describes a scheme for detecting the presence of a watermark in broadcast video content. In this paper, the height of the resulting correlation peaks are compared to a threshold to decide whether the audio/video content is watermarked or not. The threshold value is chosen such that the false positive probability (the probability of declaring a watermark present, when in fact the audio/video is not watermarked) is suitably low. A typical threshold value is 5σ (five times the standard deviation of the correlation results).

In most applications the watermarked content will undergo various processing operations between the point at which a watermark is embedded in the content and the point at which the presence of the watermark is detected. A common example of content processing is lossy compression, such as MPEG coding. Typically, the effects of processing are to lower the correlation peaks that would normally be expected to occur during the watermark detection process. Thus, the performance of a watermark detection technique based on finding correlation peaks is considerably reduced when attempting to detect watermarks in content which has undergone such processes.

The present invention seeks to provide an improved way of detecting a watermark in an information signal.

Accordingly, a first aspect of the present invention provides a method of detecting a watermark in an information signal, comprising:

deriving a set of correlation results by correlating the information signal with a watermark for each of a plurality of relative positions of the information signal with respect to the watermark; and

determining whether a watermark is present by comparing at least part of the set of correlation results with information about an expected shape of a correlation peak in the results.

Using information about an expected shape of the correlation peak can improve the sensitivity of the detector. This is because the detector can ‘look’ for a peak of a particular shape, rather than just relying on the occurrence of a point above a certain height.

The ability to detect watermarks that are only weakly present in an item of media content also provides the option of allowing the watermark to be more weakly embedded in the content, thereby reducing its visibility under inspection by potential fraudulent parties, or reducing it's perceptibility under normal viewing conditions.

The functionality described here can be implemented in software, hardware or a combination of these. Accordingly, another aspect of the invention provides software for performing the method. It will be appreciated that software may be installed on the host apparatus at any point during the life of the equipment. The software may be stored on an electronic memory device, hard disk, optical disk or other machine-readable storage medium. The software may be delivered as a computer program product on a machine-readable carrier or it may be downloaded directly to the apparatus via a network connection.

Further aspects of the invention provide a watermark detector for performing any of the steps of the method and an apparatus for presenting an information signal which responds to the output of the watermark detector.

While the described embodiment makes reference to processing an image or video signal (including digital cinema content), it will be appreciated that the information signal can be data representing audio or any other kind of media content.

Embodiments of the present invention will now be described, by way of example only, with reference to the accompanying drawings, in which:—

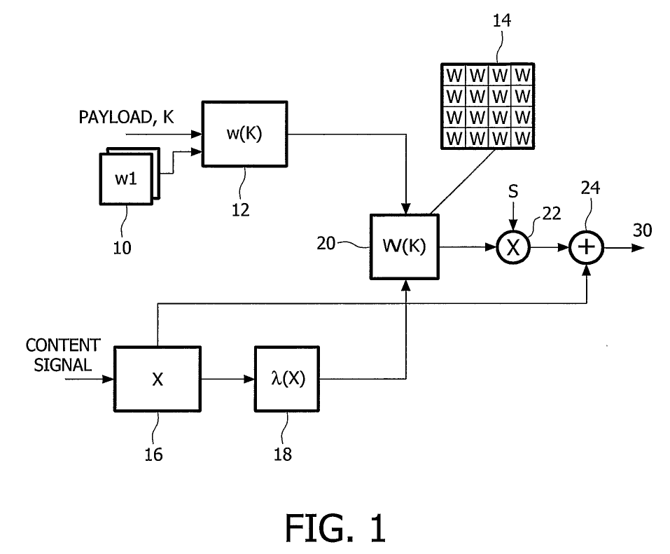

FIG. 1 shows a known way of embedding a watermark in an item of content;

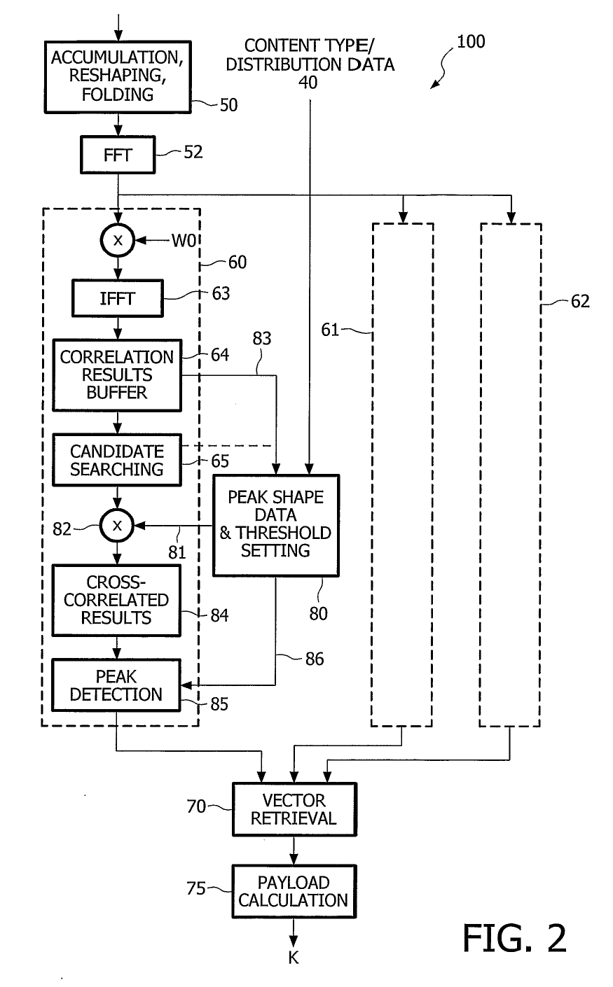

FIG. 2 shows a first arrangement for detecting the presence of a watermark in an item of content;

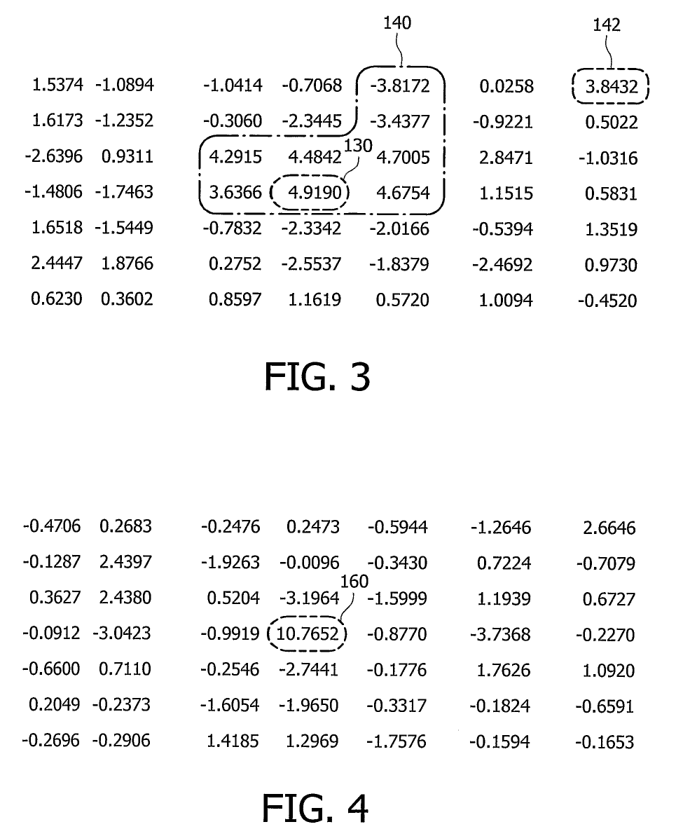

FIGS. 3 and 4 show tables of correlation results for use in the detector and method;

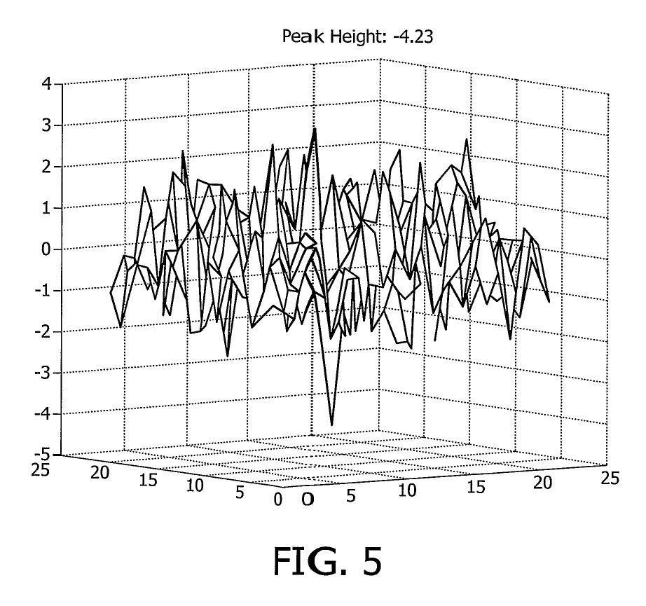

FIG. 5 shows a graph of correlation result data;

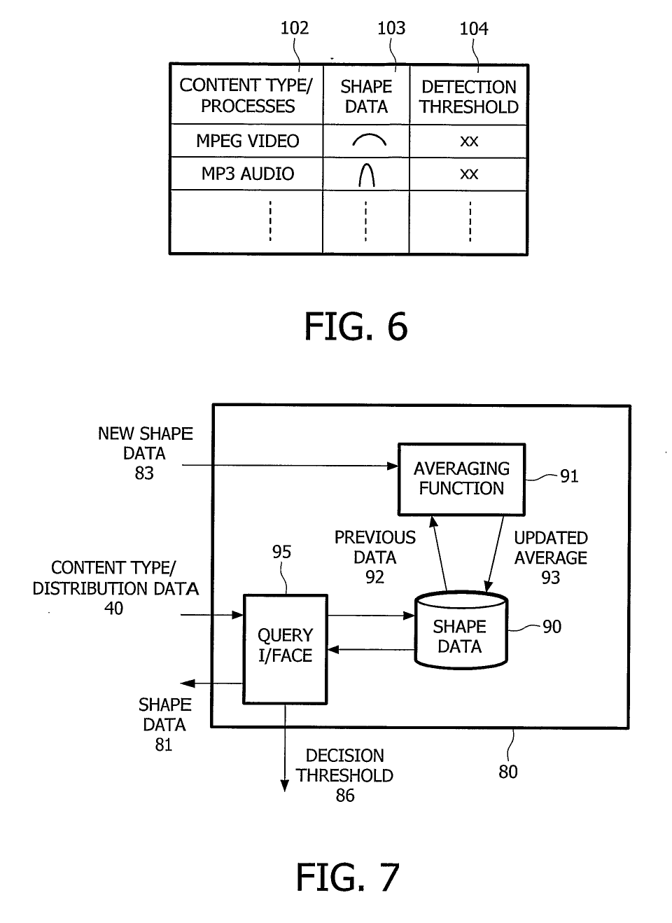

FIG. 6 shows an example of stored shape data used in the arrangement of FIG. 2;

FIG. 7 shows a unit for storing shape data;

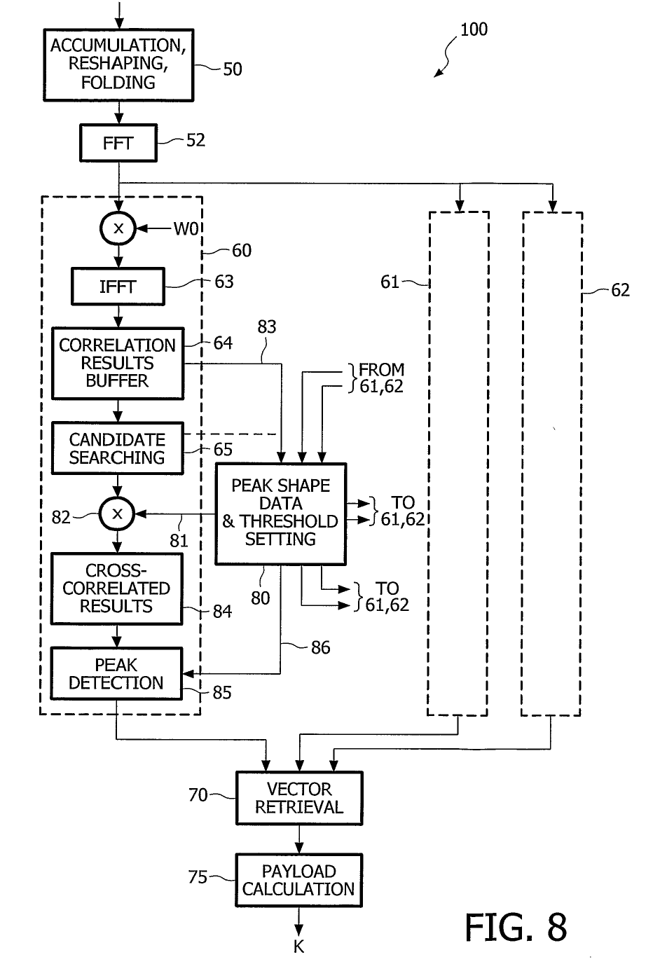

FIG. 8 shows a second arrangement for detecting the presence of a watermark in an item of content;

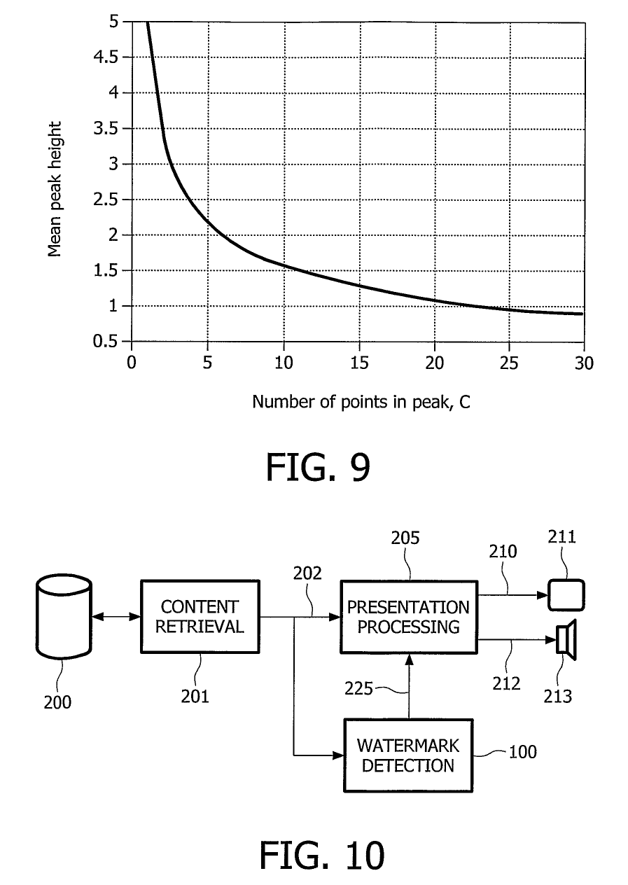

FIG. 9 shows a graph which illustrates the effect of basing detection on clusters of correlation results;

FIG. 10 shows apparatus for presenting content which embodies the watermark detector.

By way of background, and to understand the invention, a process of embedding a watermark will be briefly described, with reference to FIG. 1. A watermark pattern w(K) is constructed using one or more basic watermark patterns w. Where a payload of data is to be carried by the watermark, a number of basic watermark patterns are used. The watermark pattern w(K) is chosen according to the payload—a multi-bit code K—that is to be embedded. The code is represented by selecting a number of the basic patterns w and offsetting them from each other by a particular distance and direction. The combined watermark pattern w(K) represents a noise pattern which can be added to the content. The watermark pattern w(K) has a size of M×M bits and is typically much smaller than the item of content. Consequently, the M×M pattern is repeated (tiled) 14 into a larger pattern which matches the format of the content data. In the case of an image, the pattern w(K) is tiled 14 such that it equals the size of the image with which it will be combined.

A content signal is received and buffered 16. A measure of local activity λ(X) in the content signal is derived 18 at each pixel position. This provides a measure for the visibility of additive noise and is used to scale the watermark pattern W(K). This prevents the watermark from being perceptible in the content, such as areas of equal brightness in an image. An overall scaling factor s is applied to the watermark at multiplier 22 and this determines the overall strength of the watermark. The choice of s is a compromise between the degree of robustness that is required and the requirement for how perceptible the watermark should be. Finally, the watermark signal W(K) is added 24 to the content signal. The resulting signal, with the watermark embedded within it, will then be subject to various processing steps as part of the normal distribution of that content.

FIG. 2 shows a schematic diagram of a watermark detector 100. The watermark detector receives content that may be watermarked. In the following description the content is assumed to be images or video content. Watermark detection may be performed for individual frames or for groups of frames. Accumulated frames are partitioned into blocks of size M×M (e.g. M=128) and then folded into a buffer of size M×M. These initial steps are shown as block 50. The data in the buffer is then subject to a Fast Fourier Transform 52. The next step in the detection process determines the presence of watermarks in the data held in the buffer. To detect whether or not the buffer includes a particular watermark pattern W, the buffer contents and the expected watermark pattern are subjected to correlation. As the content data may include multiple watermark patterns, a number of parallel branches 60, 61, 62 are shown, each one performing correlation with one of the basic watermark patterns W0, W1, W2. One of the branches is shown in more detail. The correlation values for all possible shift vectors of a basic pattern Wi are simultaneously computed. The basic watermark pattern Wi (i=0, 1, 2) is subjected to a Fast Fourier Transform (FFT) before correlation with the data signal. The set of correlation values is then subject to an inverse Fast Fourier transform 63. Full details of the correlation operation are described in U.S. Pat. No. 6,505,223 B1.

The Fourier coefficients used in the correlation are complex numbers, with a real part and an imaginary part, representing a magnitude and a phase. It has been found that the reliability of the detector is significantly improved if the magnitude information is thrown away and the phase is considered only. A magnitude normalization operation can be performed after the pointwise multiplication and before the inverse Fourier Transform 63. The operation of the normalization circuit comprises pointwise dividing each coefficient by its magnitude. This overall detection technique is known as Symmetrical Phase Only Matched Filtering (SPOMF).

The set of correlation results from the above processing are stored in a buffer 64. A small example set of correlation results are shown in FIG. 3. Watermarked content is indicated by the presence of peaks in the correlation results data. The shape of the peak can be better understood by viewing the correlation results in the form of a graph, with the correlation value being plotted as height above a base line of the graph, as shown in FIG. 5. The set of correlation results are examined to identify peaks that might be due to the presence of a watermark in the content data. The presence of a watermark may be indicated by a sharp, isolated peak of significant height, although most isolated peaks tend to represent spurious matches due to noise. It is more likely that previous processing operations during distribution of the content will have caused a correlation peak due to a watermark to be smeared over several adjacent positions in the correlation results. An initial processing stage 65 identifies candidate clusters of correlation results data which may represent correlation peaks. A technique for identifying candidate peaks is described in more detail later.

Once candidate peaks have been identified, they are each tested to determine which represents a correlation peak that is due to a watermark. The correlation results in a cluster are cross-correlated 82 with data 81 from a store 80, representing an expected peak shape. The result of this cross-correlation gives an indication of the similarity between the shape of the data stored in the buffer 64 and the expected shape. The cross-correlation result is compared with a threshold at peak detection unit 85. The threshold used in this comparison 85 is not a constant value, but is set in an adaptive manner according to the expected shape. The threshold depends upon the sum of squares of the expected peak height, which might be termed the energy of the expected peak shape. This has the effect of normalising the cross-correlation result. This step reduces the occurrence of false matches between the actual cluster of results and the expected shape of results just because the expected shape has high energy. Effectively, this requires the expected peak shape to be of unit energy.

The stored shape data also be used as part of the candidate searching stage 65. For example, knowing that a relatively flat shape is expected, the candidate searching stage 65 can lower the threshold that it uses to select candidate clusters so that low peaks in the correlation results are not excluded.

There are various ways in which the stored shape data can be collected. Shape data can be provided as a file which accompanies the detector 100 and which is installed along with the detector. Updates can be provided on a periodic basis. Alternatively, or in addition to using an initial set of data, it is possible for the detector to acquire shape data based on the correlation results that it observes, in use.

A table of shape data can be stored, the table being arranged according to: processes that a content signal has undergone during distribution, type of content signal, or the type of distribution channel. Each type of processing that a content signal undergoes during distribution will have an effect on the data in that signal, and this will affect the shape of the correlation peak when the detector 100 tests for the presence of a watermark. The effect of each process can be observed and stored as shape information in unit 80. Where it is possible to quantify what processes a content signal has undergone during distribution, it is possible to apply an appropriate shape in the cross-correlation stage 82 of the detector. Where a signal has undergone multiple processes (e.g. MPEG coding and coding for transmission over a wireless channel) multiple shape data can be combined, or an appropriate template corresponding to a particular combination of processes can be retrieved. Templates can be stored for a range of commonly used content types or distribution methods, e.g. MPEG video received over a broadcast channel; MP3 audio content received via a wired connection; content received via a wireless connection. Information about the type of content or distribution is provided as input 40 to unit 80, the information 40 being obtained from another part of the receiver. Templates can be provided for different content bit rates e.g. MPEG 2 Mbps, 4 Mbps, 6 Mbps etc., format conversion e.g. PAL->NTSC, NTSC->PAL, and also combinations of MPEG and format conversion. This table of data would be determined by the manufacturer of the watermark detector, and the relevant settings programmed into the detector at installation. Templates can be changed by updates to the detector.

The shape data comprises a set of numerical values that together define the shape of an expected peak. The shape arises from the relative size of the numerical values in the set. The set of values can be scaled to any size. Thus, it is the shape of the peak rather than the size which is compared in the cross-correlation stage 82. FIG. 6 shows an example of the kind of table of shape information that can be stored by unit 80. Each type of content, process or combination of processes 102 is associated with shape data 103 and a detection threshold 104 for use by unit 85. Although the shape data 103 is shown here in graphical form it will, in fact, comprise a set of numerical values which together define an expected peak shape.

The use of stored data in this way may not be possible where, for example, the detector does not receive information 40 about what processes the content has undergone or where the receiving equipment itself does not know this information. In this case, various techniques can be used to estimate the expected peak shape. FIG. 7 shows an embodiment in which a moving average of shape data is acquired over a period of time. New peak shape information 83 from the correlation results buffer (or candidate searching unit 65) is sent to an averaging function 91. Previous shape data, such as a previous running average, is retrieved 92 from the stored data 90, a new average is calculated, and the updated average is returned 93 for storage. The moving average can be calculated over the previous D detections. The value of D is application dependent and will depend on the number of detections performed per second relative to the time period for which the content/processing remains constant. This approach can be particularly successful where the processing applied to the content remains constant over several detection periods. Where information about the type of content, or distribution processes or channel for the content are known, a plurality of stored templates can be acquired over a period of time, each associated with those processes or channels. Referring again to FIG. 7, the unit 80 also includes a suitable interface 95 which receives information 40 and retrieves the appropriate shape data and threshold from the store 90. The shape data 81 is sent to cross-correlator 82 and decision threshold data 86 is sent to peak detection unit 85.

FIG. 8 shows a further development of the invention. Each branch 60, 61, 62 of the detector 100 includes the features which are shown, in detail, in branch 60. Unit 80 acquires shape data from buffers 64 of each branch 60, 61, 62 and combines the data to derive an overall shape template. The combined data and decision threshold data can then be applied to the correlation units 82 in each of the branches 60, 61, 62.

A simplified mathematical example of the shape matching process will now be described. Consider that an item of content has been correlated with a watermark pattern of interest using the SPOMF technique previously described and the correlation results stored in buffer 64. The correlation results in buffer 64 are a vector y of correlation values with each element corresponding to a different (cyclic) shift of the watermark pattern relative to the content signal. For clarity it is assumed that y is one-dimensional although it will be appreciated that for most content the correlation results in buffer 64 will be a two-dimensional matrix corresponding to shifts in the horizontal and vertical directions. In the case of unwatermarked material ( H̅_̅{̅W̅}̅) it has been shown that the elements of y are approximately independent White Gaussian Noise (WGN). In the case of watermarked material (H_{W}), experiment shows that the buffer results are again approximately gaussian noise, but there also exists a peak. Suppose that the form of the correlation peak, for a payload shift τ, can be described by:

$${s}_{τ} ( k ) = A {\sum }_{i = 0}^{C - 1} {a}_{i} δ ( k - τ - i ) \qquad ( 1 )$$

This is a very general model of the correlation peak that considers its extent to be C adjacent positions in the buffer, with it's shape determined by:

a=[a₀a₁, . . . a_{C-1}]^{T}

and its height to be given by the scale factor A. The known (expected) peak shape a is cross-correlated with the buffer contents y, and then compared with a threshold to decide whether the watermark is present (H_{W}), or not ( H̅_̅{̅W̅}̅). The payload shift estimate \hat{τ} is taken as the position maximising the cross-correlation.

$$\vert {\sum }_{i = 0}^{C - 1} {a}_{i} y ( \hat{τ} + i ) \vert > h ⇒ {H}_{W} else \overline{{H}_{W}}$$

The derivation of this detection criterion is provided in the appendix.

As a simple example of the benefit of using the peak shape information, consider the case where it is known that the peak shape is flat, i.e.

aᵢ=a,∀iε{0 . . . C−1}

FIG. 9 shows the minimum mean height required of the buffer results yᵢ at the position corresponding to the watermark peak in order for the watermark to be declared present. These have been calculated so as to achieve the same false positive probability as an existing detection method with a simple threshold of 5σ. It can be seen that for widely spread peak shapes, i.e. large clusters of C points, the watermark can successfully be detected at peak heights much lower than the 5σ level required by the current detectors.

A process for identifying candidate correlation peaks in the correlation results, for use in unit 65 of FIGS. 2 & 8, will now be described. The clustering algorithm forms a number of clusters of points, any of which may correspond to the true correlation peak. The likelihoods of these clusters are compared, and the cluster with the lowest likelihood is assumed to be the wanted correlation peak. The algorithm comprises the following steps:

1. Set a threshold value and find all points in the correlation data which are above this threshold value. All points meeting this criteria are stored in a list—ptsAboveThresh. A suggested threshold value is 3.3σ (σ=standard deviation of results in the buffer) although this can be set to any preferred value. A preferred range is 2.5-4σ. If the threshold value is set too low a large number of points, which do not correspond to the presence of a watermark, will be stored in the list. Conversely, if the value is set too high there is a risk that points corresponding to a valid, but smeared, peak will not be added to the list.

2. Find the point with the highest absolute value.

3. Form candidate clusters, i.e. clusters of correlation points. Candidate clusters are formed by collecting points that not only have ‘significant’ value (a value greater than the threshold), but which are also located very close to at least one other point of significant value. This is achieved as follows:
(i) Remove the first point from the ptsAboveThresh list and enter it as the first point p of a new cluster;
(ii) Search ptsAboveThresh for points that are within a distance d of point p. Remove all such points from the ptsAboveThresh list, and add them to the cluster;
(iii) Take the next point in the cluster as the current point p. Repeat step (ii) in order to add to the cluster all points in ptsAboveThresh that are within distance d of the new point p.
(iv) Repeat Step (iii) until ptsAboveThresh has been processed for all points in the cluster;
(v) If the resulting cluster consists of only a single point and that point is not equal to the highest peak found in Step 2 above, then discard this cluster;
(vi) Repeat Steps (i) to (v) until ptsAboveThresh is empty.
   At the end of this procedure, all points originally entered into ptsAboveThresh in Step 1 above have been either:
assigned to a cluster containing other points from the ptsAboveThresh list that are close to it, or
discarded, as they have no neighbours of similar height, and are therefore not part of a cluster.

A cluster is only allowed to comprise a single point if that point has the largest absolute height of all the points in the correlation buffer. This prevents a sharp, unsmeared, correlation peak from being discarded, but prevents other isolated peaks, representing true noise, from being used.

Referring back to FIGS. 3 and 4, these show some example sets of correlation data of the type that that would be calculated by the detector. FIG. 3 shows a set of results for a smeared peak, with values ranging between −3.8172 and 4.9190. Watermarks may be embedded with negative amplitude, giving a negative correlation peak. The highest value of 4.9190 is shown within box 130. Although this is below the typical detection threshold of 5, the highest value is surrounded by other correlation values of a similar value. This is indicative of a peak which has been smeared by processing during the distribution chain. Following the procedure described above, and setting a threshold T of 3.3 and a distance of 1, it can be found that the correlation values within ring 140 meet this criteria. Working through the process, the results of significant value are all located alongside each other. Looking at the data shown in FIG. 4, the values range between −3.7368 and 10.7652. Applying the same detection criteria, only one point 160 exceeds the threshold. The value of this point clearly exceeds the threshold and thus is considered to be a valid peak. From inspecting the neighbouring values, it can be seen that this represents a sharp correlation peak.

The embedded information represented as payload code K may identify, for example, the copy-right holder or a description of the content. In DVD copy-protection, it allows material to be labelled as ‘copy once’, ‘never copy’, ‘no restriction’, ‘copy no more’, etc. FIG. 10 shows an apparatus for retrieving and presenting a content signal which is stored on a storage medium 200, such as an optical disk, memory device or hard disk. The content signal is retrieved by a content retrieval unit 201. The content signal 202 is applied to a processing unit 205, which decodes the data and renders it for presentation 211, 213. The content signal 202 is also applied to a watermark detection unit 220 of the type previously described. The processing unit 205 is arranged so that it is only permitted to process the content signal if a predetermined watermark is detected in the signal. A control signal 225 sent from the watermark detection unit 220 informs the processing unit 205 whether processing of the content should be allowed or denied, or informs the processing unit 205 of any copying restrictions associated with the content. Alternatively, the processing unit 205 can be arranged so that it is only permitted to process the content signal if a predetermined watermark is not detected in the signal.

In the above description, a set of three watermarks have been considered. However, it will be appreciated that the technique can be applied to find a correlation peak in content data carrying only a single watermark, or to content data carrying any number of multiple watermarks.

In the description above, and with reference to the Figures, there is described a detector 100 which detects the presence of a watermark in an information signal. The information signal is correlated with an expected watermark Wi for each of a plurality of relative positions of the information signal with respect to the watermark to derive a set of correlation results 64. Part of the correlation results 64 are cross-correlated 82 with information 81 about an expected shape of a correlation peak in the results. This can improve the sensitivity of the detector 100. The cross-correlation result 84 is compared with a threshold at peak detection unit 85. The threshold used in this comparison 85 is set in an adaptive manner according to the expected shape. The information 81 about an expected shape of the correlation peak can be based on knowledge of processing operations that the information signal has undergone or expected to have undergone or from the shape of previous correlation results.

### APPENDIX

This section derives the example detection algorithm given earlier, and describes how to set the detection threshold to achieve a desired false positive probability.
Suppose that for watermarked content (H_{W}) the correlation results are a peak due to the watermark, plus WGN. This is supported by the observation that, with the exception of the peak itself, in the case of watermarked content the correlation results are again approximately gaussian distributed. The following hypothesis test can then be written for detecting the presence of a watermark:

H̅_̅{̅W̅}̅:y=n

H_{W}:y=n+s_{τ}

where n is a length N vector of independent WGN values and s_{τ} is a length N vector corresponding to the watermark correlation peak shape, cyclically shifted by τ positions within the correlation buffer. In the work that follows it is assumed that the noise has a standard deviation of unity. This is achieved by normalising the correlation results prior to watermark detection. Assuming momentarily that both the peak shape s and payload shift τ are known, the PDFs under each hypothesis are as follows. Under H̅_̅{̅W̅}̅ the values in y are pure WGN with PDF:

$$\begin{matrix}p ( y \vert \overline{{H}_{W}} ) = {\prod }_{k = 0}^{N - 1} {( 2 π )}^{- \frac{1}{2}} exp [ - \frac{1}{2} {y}^{2} ( k ) ] \\ = {( 2 π )}^{- \frac{N}{2}} exp [ - \frac{1}{2} {\sum }_{k = 0}^{N - 1} {y}^{2} ( k ) ]\end{matrix}$$

Under H_{W} the buffer contains a peak plus WGN and has PDF:

$$\begin{matrix}p ( y \vert {H}_{W} , s , τ ) = {\sum }_{k = 0}^{N - 1} {( 2 π )}^{\frac{1}{2}} exp [ - \frac{1}{2} {( y ( k ) - {s}_{τ} ( k ) )}^{2} ] \\ = {( 2 π )}^{- \frac{N}{2}} exp [ - \frac{1}{2} {\sum }_{k = 0}^{N - 1} {( y ( k ) - {s}_{τ} ( k ) )}^{2} ]\end{matrix} \qquad ( 3 )$$

A decision between the two hypotheses will be made using a likelihood ratio test:

$$Likelihood ( y \vert s , τ ) = \frac{p ( y \vert {H}_{W} , s , τ )}{p ( y \vert \overline{{H}_{W}} )} > λ ⇒ {H}_{W} else \overline{{H}_{W}} \qquad ( 4 )$$

where the log-likelihood ratio is:

$$\begin{matrix}L ( y \vert s , τ ) = ln [ Likelihood ( y \vert s , τ ) \\ = - \frac{1}{2} {\sum }_{k = 0}^{N - 1} {( y ( k ) - {s}_{τ} ( k ) )}^{2} + \frac{1}{2} {\sum }_{k = 0}^{N - 1} {y}^{2} ( k ) \\ = {\sum }_{k = 0}^{N - 1} y ( k ) {s}_{τ} ( k ) - \frac{1}{2} {\sum }_{k = 0}^{N - 1} {s}_{τ}^{2} ( k )\end{matrix} \qquad ( 5 )$$

The following model of the watermark correlation peak s_{τ} is assumed:

$${s}_{τ} ( k ) = A {\sum }_{i = 0}^{C - 1} {a}_{i} δ ( k - τ - i ) \qquad ( 6 )$$

This describes a peak spanning C points, which has known shape, given by a, but unknown overall height, given by the scale factor A. It is assumed that C is known. In practice, an estimated value would need to be used based upon the typical extent of spread of watermark correlation points, or a value of C can be obtained using the cluster detection technique described earlier. Substituting Equation 6 into the log-likelihood expression of Equation 5 gives:

$$L ( y \vert a , A , τ ) = A {{\sum }_{i - 0}}^{C - 1} {a}_{i} y ( τ + i ) - \frac{{A}^{2}}{2} {\sum }_{j = 0}^{C - 1} {a}_{j}^{2}$$

The unknown parameters (A, τ) will be estimated by the values that maximize the likelihood of the observed data (y). Maximising with respect to the unknown peak height gives:

$$\frac{\partial L ( y \vert a , A , τ )}{\partial A} = 0 ⇒ \hat{A} = \frac{{\sum }_{i = 0}^{C - 1} {a}_{i} y ( τ + i )}{{\sum }_{j = 0}^{C - 1} {a}_{j}^{2}}$$

and the log-likelihood becomes:

$${\hat{L}}_{ML} ( y \vert a , τ ) = \frac{{( {\sum }_{i = 0}^{C - 1} {a}_{i} y ( τ + i ) )}^{2}}{2 {\sum }_{j = 0}^{C - 1} {a}_{j}^{2}}$$

Choosing the estimate \hat{τ} of the payload shift to maximize the likelihood gives:

$${\hat{L}}_{ML} ( y \vert a ) = \frac{{( {\sum }_{i = 0}^{C - 1} {a}_{i} y ( \hat{τ} + i ) )}^{2}}{2 {\sum }_{j = 0}^{C - 1} {a}_{j}^{2}}$$

Note that the summation in the denominator is a constant that has no dependence upon the correlation results in y. The likelihood ratio decision rule therefore reduces to a threshold test on the magnitude of the cross-correlation between y and the peak shape a:

$$\vert {\sum }_{i = 0}^{C - 1} {a}_{i} y ( \hat{τ} + i ) \vert > h ⇒ {H}_{W} else \overline{{H}_{W}}$$

where \hat{τ} is chosen as the shift maximising the cross-correlation. The necessary threshold value h to achieve an acceptably low false positive probability of value α is given by:

$$Pr [ False positive ] = Pr [ \vert {\sum }_{i = 0}^{C - 1} {a}_{i} y ( \hat{τ} + i ) \vert > h \vert \overline{{H}_{W}} ] = α \qquad ( 8 )$$

Under hypothesis H̅_̅{̅W̅}̅ the elements of are independently gaussian distributed with zero mean and unit standard deviation. The variable γ, defined as:

$$γ ( k ) = {\sum }_{i = 0}^{C - 1} {a}_{i} y ( k + i )$$

therefore also has a gaussian distribution but with standard deviation

$${σ}_{y} = \sqrt{{\sum }_{i = 0}^{C - 1} {a}_{i}^{2}} .$$

Using this notation, Equation 8 becomes:

$$Pr [ γ ( k ) < - h , ∀ k ] + Pr [ γ ( k ) > + h , ∀ k ] = α \\ ⇒ 2 [ 1 - {( Pr [ γ < h ] )}^{N} ] = α \\ ⇒ Pr [ γ < h ] = {( 1 - \frac{α}{2} )}^{\frac{1}{N}} \\ ⇒ Φ ( \frac{h}{{σ}_{y}} ) = {( 1 - \frac{α}{2} )}^{\frac{1}{N}}$$

from which the appropriate value of h can be determined via tables of Φ(α)=Pr(Z<α), where Z is a zero mean, unit standard deviation gaussian random variable. The dependence of the detection threshold upon σ_{y} provides adjustment according to the energy of the given peak shape, such that the desired false positive probability is attained.

1. A method of detecting a watermark in an information signal, comprising:
deriving a set of correlation results by correlating the information signal with a watermark for each of a plurality of relative positions of the information signal with respect to the watermark; and
determining whether a watermark is present by comparing at least part of the set of correlation results with information about an expected shape of a correlation peak in the results.

2. A method according to claim 1 wherein the comparing comprises a cross-correlation of at least part of the set of correlation results with information about the expected shape of a correlation peak.

3. A method according to claim 1 further comprising comparing the output of comparison with a threshold value to determine the presence of a valid watermark.

4. A method according to claim 3 wherein the threshold value varies according to the expected shape of the correlation peak.

5. A method according to claim 1 wherein the information about an expected shape of the correlation peak is derived from knowledge of processing operations that the information signal has undergone or expected to have undergone.

6. A method according to claim 1 wherein the information about an expected shape of the correlation peak is derived from the shape of previous correlation results.

7. A method according to claim 6 wherein the previous correlation results are results for: the same type of information signal; an information signal which has been subject to the same processing steps; an information signal which has been distributed through the same channel.

8. A method according to claim 1 further comprising identifying clusters of correlation results which are likely to represent correlation peaks and performing the step of determining whether a watermark is present only on the identified clusters of results.

9. A method according to claim 8 wherein the step of identifying clusters of correlation results comprises determining all correlation results in the set which exceed the threshold value and then determining which of those correlation results are located within a predetermined distance of each other.

10. A method according to claim 1 wherein a plurality of watermarks are used, the step of deriving a set of correlation results being repeated for each watermark, the method further comprising determining information about the shape of a correlation peak in the correlation results for one of the watermarks, and using that information in a comparison for another of the watermarks.

11. (canceled)

12. A watermark detector for detecting a watermark in an information signal, comprising:
means for deriving a set of correlation results by correlating the information signal with a watermark for each of a plurality of relative positions of the information signal with respect to the watermark; and
means for determining whether a watermark is present by comparing at least part of the set of correlation results with information about an expected shape of a correlation peak in the results.

13. (canceled)

14. A watermark detector according to claim 12 wherein the means for deriving a set of correlation results and the means for determining whether a watermark is present comprise a processor which is arranged to execute software for performing those functions.

15. Apparatus for presenting an information signal comprising means for disabling operation of the apparatus in dependence on the presence of a valid watermark in the information signal, wherein the apparatus comprises a watermark detector according to claim 12.

16. A watermark detector for detecting a watermark in an information signal, comprising:
a processor for deriving a set of correlation results by correlating the information signal with a watermark for each of a plurality of relative positions of the information signal with respect to the watermark; said processor determining whether a watermark is present by comparing at least part of the set of correlation results with information about an expected shape of a correlation peak in the results.
